(19) United States
(12) Patent Application Publication
(10) Pub. No.: US 2025/0105961 A1
(43) Pub. Date: Mar. 27, 2025

(54) BEAM LINK FAILURE STATUS INFORMATION

(71) Applicant: Nokia Technologies Oy, Espoo (FI)

(72) Inventors: Samuli Heikki TURTINEN, Oulu (FI); Timo KOSKELA, Oulu (FI)

(21) Appl. No.: 18/291,458

(22) PCT Filed: Feb. 13, 2023
(86) PCT No.: PCT/EP2023/053515

§ 371 Date: Jan. 23, 2024

(30) Foreign Application Priority Data
Feb. 14, 2022 (FI) 20225132

(51) Int. Cl. H04L 5/00

(52) U.S. Cl. CPC H04L 5/0048

(57) ABSTRACT

To report failure status information, an apparatus may receive, from a base station, configuration information configuring two or more beam failure detection reference signal sets for one or more serving cells, wherein at least one of the one or more serving cells is configured with multiple beam failure detection reference signal sets comprising at least a first beam failure detection reference signal set and a second beam failure detection reference signal set. The apparatus may monitor, whether beam failure is detected based on the configuration information and encode, when the beam failure is detected for the first beam failure detection reference signal set and the second beam failure detection reference signal set, into at least two bitmaps in a medium access control control element, MAC CE, failure status information of the first beam failure detection reference signal set and failure status information of the second beam failure detection reference signal set; and transmit the MAC CE comprising the failure status information.

### TECHNICAL FIELD

Various example embodiments relate to wireless communications.

### BACKGROUND

Wireless communication systems are under constant development. Use cases range from enhanced mobile broadband and ultra-reliable and low latency communications to massive machine-type communications, having in-between use cases, such as sensor networks, or video surveillance. One way to improve reliability, coverage, and capacity performance is to use beams and multiple transmission and reception points.

### BRIEF DESCRIPTION

The subject matter of the independent claims defines the scope.

According to an aspect there is provided an apparatus comprising at least one processor; and at least one memory including instructions, the at least one memory and instructions being configured to, with the at least one processor, cause the apparatus at least to: receive, from a base station, configuration information configuring two or more beam failure detection reference signal sets for one or more serving cells, wherein at least one of the one or more serving cells is configured with multiple beam failure detection reference signal sets comprising at least a first beam failure detection reference signal set and a second beam failure detection reference signal set; monitor, whether beam failure is detected based on the configuration information; encode, when the beam failure is detected for the first beam failure detection reference signal set and the second beam failure detection reference signal set, into at least two bitmaps in a medium access control control element, MAC CE, failure status information of the first beam failure detection reference signal set and failure status information of the second beam failure detection reference signal set; and transmit the MAC CE comprising the failure status information.

In embodiments, the at least one memory including the instructions are configured to, with the at least one processor, cause the apparatus to: encode into a first bitmap in the MAC CE at least the failure status information of the first beam failure detection reference signal set; and encode into a second bitmap in the MAC CE at least the failure status information of the second beam failure detection reference signal set.

In embodiments, the at least one memory including the instructions are configured to, with the at least one processor, cause the apparatus to: encode, if a serving cell is not configured with the multiple beam failure detection reference signal sets, into the first bitmap failure status information of said serving cell.

In embodiments, the at least one memory including the instructions are configured to, with the at least one processor, cause the apparatus to: prioritize, when the failure status information is to be transmitted in a truncated medium access control element in a random access channel, failure status information of one or more beam failure detection reference signal sets for a primary cell or a primary secondary cell in the second bitmap over failure status information of secondary cells in the first bitmap.

In embodiments, the at least one memory including the instructions are configured to, with the at least one processor, cause the apparatus to: perform the prioritizing by encoding first the failure status information of one or more beam failure detection reference signal sets for the primary cell or the primary secondary cell to the first bitmap and to the second bitmap, then if there is free space left encoding other failure status information into the first bitmap and into the second bitmap.

In embodiments, the at least one memory including instructions are configured to, with the at least one processor, cause the apparatus to: encode, according to a predefined rule, into one bitmap failure status information of beam failure detection of at least the first beam failure detection reference signal set and the second beam failure detection reference signal set for the at least one of the serving cells configured with the multiple beam failure detection reference signal sets.

In embodiments, the predetermined rule is one of encode the beam failure detection reference signal sets in the order of the serving cells; encode the first beam failure detection reference signal set and the second beam failure detection reference signal set for a serving cell in adjacent bit positions; encode the first beam failure detection reference signal set and the second beam failure detection reference signal set in a sequential manner per a serving cell in an ascending order of serving cell index; or encode the first beam failure detection reference signal set and the second beam failure detection reference signal set for a predefined number of serving cells in the sequential manner.

According to an aspect there is provided a method comprising: receiving, by a use device, configuration information configuring two or more beam failure detection reference signal sets for one or more serving cells, wherein at least one of the one or more serving cells is configured with multiple beam failure detection reference signal sets comprising at least a first beam failure detection reference signal set and a second beam failure detection reference signal set; monitoring, by the user device, whether beam failure is detected based on the configuration information; encoding, by the user device, when the beam failure is detected for the first beam failure detection reference signal set and the second beam failure detection reference signal set, into at least two bitmaps in a medium access control control element, MAC CE, failure status information of the first beam failure detection reference signal set and failure status information of the second beam failure detection reference signal set; and transmitting, by the user device, the MAC CE comprising the failure status information.

In embodiments, the method comprising: encoding, by the user device, into a first bitmap in the MAC CE at least the failure status information of the first beam failure detection reference signal set; and encoding, by the user device, into a second bitmap in the MAC CE at least the failure status information of the second beam failure detection reference signal set.

In embodiments, the method comprising: encoding, by the user device, into the first bitmap failure status information of said serving cell, if a serving cell is not configured with the multiple beam failure detection reference signal sets.

In embodiments, the method comprising: prioritizing, when the failure status information is to be transmitted in a truncated medium access control element in a random access channel, failure status information of one or more beam failure detection reference signal sets for a primary cell or a primary secondary cell in the second bitmap over failure status information of secondary cells in the first bitmap.

In embodiments, the method comprising: performing, by the user device, the prioritizing by encoding first the failure status information of one or more beam failure detection reference signal sets for the primary cell or the primary secondary cell to the first bitmap and to the second bitmap, then if there is free space left encoding other failure status information into the first bitmap and into the second bitmap.

In embodiments, the method comprising: encoding, according to a predefined rule, into one bitmap failure status information of beam failure detection of at least the first beam failure detection reference signal set and the second beam failure detection reference signal set for the at least one of the serving cells configured with the multiple beam failure detection reference signal sets.

In embodiments, the predetermined rule is one of: encoding the beam failure detection reference signal sets in the order of the serving cells; encoding the first beam failure detection reference signal set and the second beam failure detection reference signal set for a serving cell in adjacent bit positions; encoding the first beam failure detection reference signal set and the second beam failure detection reference signal set in a sequential manner per a serving cell in an ascending order of serving cell index; or encoding the first beam failure detection reference signal set and the second beam failure detection reference signal set for a predefined number of serving cells in the sequential manner.

According to an aspect there is provided a computer readable medium comprising instructions which, when executed by an apparatus, cause the apparatus to carry out: receiving configuration information configuring two or more beam failure detection reference signal sets for one or more serving cells, wherein at least one of the one or more serving cells is configured with multiple beam failure detection reference signal sets comprising at least a first beam failure detection reference signal set and a second beam failure detection reference signal set; monitoring whether beam failure is detected based on the configuration information; encoding when the beam failure is detected for the first beam failure detection reference signal set and the second beam failure detection reference signal set, into at least two bitmaps in a medium access control control element, MAC CE, failure status information of the first beam failure detection reference signal set and failure status information of the second beam failure detection reference signal set; and transmitting the MAC CE comprising the failure status information.

In embodiments, the computer readable medium comprising instructions which cause the apparatus to: encode into a first bitmap in the MAC CE at least the failure status information of the first beam failure detection reference signal set; and encoding, by the user device, into a second bitmap in the MAC CE at least the failure status information of the second beam failure detection reference signal set.

In embodiments, the computer readable medium comprising instructions which cause the apparatus to: encode into the first bitmap failure status information of said serving cell, if a serving cell is not configured with the multiple beam failure detection reference signal sets.

In embodiments, the computer readable medium comprising instructions which cause the apparatus to: prioritize, when the failure status information is to be transmitted in a truncated medium access control element in a random access channel, failure status information of one or more beam failure detection reference signal sets for a primary cell or a primary secondary cell in the second bitmap over failure status information of secondary cells in the first bitmap.

In embodiments, the computer readable medium comprising instructions which cause the apparatus to: perform, by the user device, the prioritizing by encoding first the failure status information of one or more beam failure detection reference signal sets for the primary cell or the primary secondary cell to the first bitmap and to the second bitmap, then if there is free space left encoding other failure status information into the first bitmap and into the second bitmap.

In embodiments, the computer readable medium comprising instructions which cause the apparatus to: encodes, according to a predefined rule, into one bitmap failure status information of beam failure detection of at least the first beam failure detection reference signal set and the second beam failure detection reference signal set for the at least one of the serving cells configured with the multiple beam failure detection reference signal sets.

In embodiments, the predetermined rule is one of: encoding the beam failure detection reference signal sets in the order of the serving cells; encoding the first beam failure detection reference signal set and the second beam failure detection reference signal set for a serving cell in adjacent bit positions; encoding the first beam failure detection reference signal set and the second beam failure detection reference signal set in a sequential manner per a serving cell in an ascending order of serving cell index; or encoding the first beam failure detection reference signal set and the second beam failure detection reference signal set for a predefined number of serving cells in the sequential manner.

### BRIEF DESCRIPTION OF DRAWINGS

Embodiments are described below, by way of example only, with reference to the accompanying drawings, in which

FIGS. 1 and 2 illustrate exemplified wireless communication systems;

FIG. 3 illustrates exemplified information exchange;

FIG. 4 illustrates an example of status information;

FIGS. 5 to 8 are flow charts illustrating examples of functionalities; and

FIGS. 9 and 10 are schematic block diagrams.

### DETAILED DESCRIPTION OF SOME EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned. Further, although terms including ordinal numbers, such as “first”, “second”, etc., may be used for describing various elements, the structural elements are not restricted by the terms. The terms are used merely for the purpose of distinguishing an element from other elements. For example, a first signal could be termed a second signal, and similarly, a second signal could be also termed a first signal without departing from the scope of the present disclosure.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultrawideband (UWB) technology, sensor networks, mobile ad-hoc networks (MANETs) and Internet Protocol multimedia subsystems (IMS) or any combination thereof.

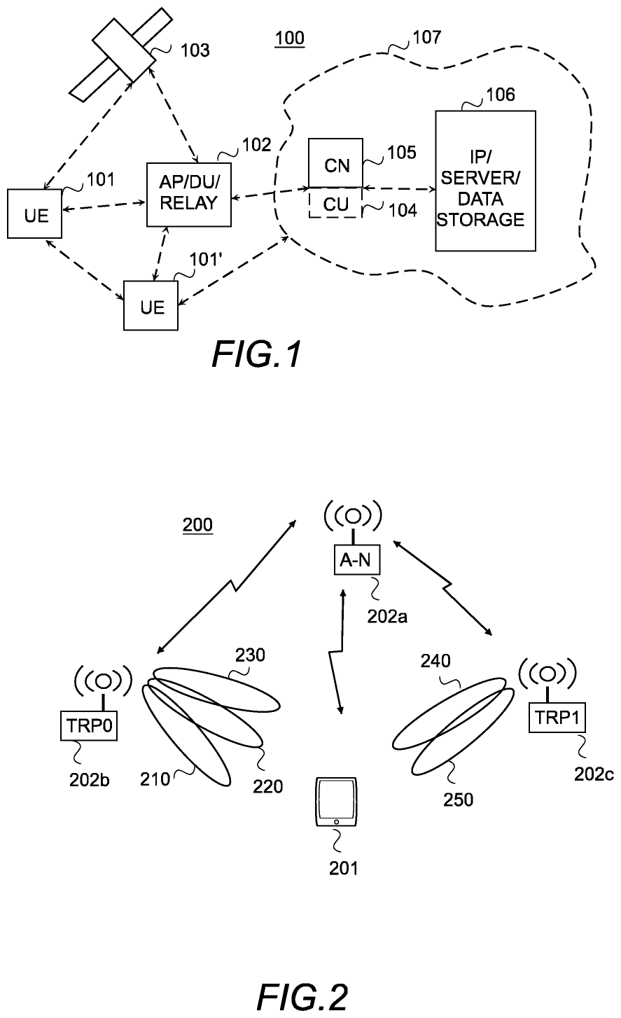

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system 100 given as an example but a person skilled in the art may apply the solution to other communication systems provided with necessary properties.

The example of FIG. 1 shows a part of an exemplifying radio access network.

FIG. 1 shows user devices 101, 101′ configured to be in a wireless connection on one or more communication channels with a node 102. The node 102 is further connected to a core network 105. In one example, the node 102 may be an access node such as (e/g) NodeB providing or serving devices in a cell. In one example, the node 102 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 105 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), or access and mobility management function (AMF), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a device (e.g. a portable or non-portable computing device) that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The user device may also utilise cloud. In some applications, a user device may comprise a user portable device with radio parts (such as a watch, earphones, eyeglasses, other wearable accessories or wearables) and the computation is carried out in the cloud. The device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors micro-controllers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 106, or utilise services provided by them. The communication network may also be able to support the usage of cloud services, for example at least part of core network operations may be carried out as a cloud service (this is depicted in FIG. 1 by “cloud” 107). The communication system may also comprise a central control entity, or a like, providing facilities for networks of different operators to cooperate for example in spectrum sharing.

The technology of Edge cloud may be brought into a radio access network (RAN) by utilizing network function virtualization (NVF) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 102) and non-real time functions being carried out in a centralized manner (in a centralized unit, CU 104).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite 103 in the mega-constellation may cover several satelliteenabled network entities that create on-ground cells. The on-ground cells may be created through an on-ground relay node 102 or by a gNB located on-ground or in a satellite.

It is obvious for a person skilled in the art that the depicted system is only an example of a part of a radio access system and in practice, the system may comprise a plurality of (e/g) NodeBs, the user device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g) NodeBs has been introduced. Typically, a network which is able to use “plug-and-play” (e/g) Node Bs, includes, in addition to Home (e/g) NodeBs (H (e/g) nodeBs), a home node B gateway, or HNB-GW (not shown in FIG. 1). A HNB Gateway (HNB-GW), which is typically installed within an operator's network may aggregate traffic from a large number of HNBs back to a core network.

It is envisaged that in 5G, 6G and beyond, multiple transmission-reception points may be utilized to serve a user device, or shortly device, for improving reliability, coverage, and capacity performance through flexible deployment scenarios. Different examples are described below using principles and terminology of 5G technology without limiting the examples to 5G.

FIG. 2 illustrates a zoom view of a radio access system 200 illustrated in FIG. 1.

Referring to FIG. 2, the radio access system 200 may comprise under control of an access node (A-N) 202a a plurality of apparatuses 202b, 202c configured to act as a transmission-reception point (TRP). Different examples of access nodes are given above.

An apparatus 202b, 202b configured to act as a transmission-reception point, called herein a transmission-reception point, may be a base station or another access node, or an operational entity comprising one or more antennas in a base station, or an operational entity comprising one or more remote radio heads, or a remote antenna of a base station, or any other set of geographically co-located antennas forming one operational entity, for example an antenna array with one or more antenna elements, for one cell in the radio access network, or for a part of the one cell. In other words, one cell may include one or multiple transmission points, and cells in the radio access network comprise transmission-reception points.

The access node 202a may configure, per a serving cell, the serving cell via one of the transmission-reception points 202b, 202c, or via two or more of the transmission-reception points 202b, 202c, the latter being called a multiple transmission-reception point configuration (mTRP configuration), or a multiple transmission-reception point operation. The mTRP configuration may be comprise, instead of an explicit indication of a transmission-reception point identifier within a physical downlink control channel configuration, an indication of a poolIndex, and transmission-reception points that have the same poolIndex may be assumed by the device 201 to be configured to be provided from the same set of transmission-reception point(s).

In the example illustrated in FIG. 2, two transmission reception points with poolIndex 0 and 1 are shown. TRP0, i.e. the transmission-reception point 202b having the poolIndex 0, provides three beams (210, 220, 230), and the transmission-reception point 202c having the poolIndex 1 provides two beams (240, 250). It should be noted that FIG. 2 is a non-limiting example illustration, and in some examples, poolIndex0 and/or poolIndex1 may comprise two or more transmission-reception points.

The mTRP may also be configured for an inter-cell scenario (sometimes referred to as inter-cell mTRP or inter-cell beam management), i.e. the transmission-reception points may be associated with different cells.

The device 201 may be configured to monitor, and the transmission-reception points 202b, 202c may be configured to transmit, beam failure detection reference signal sets transmitted over one or more of the beams 210, 220, 230, 240, 250. It may happen that at least one of the beams 210, 220, 230, 240, 250 fails, and then failure status information of the beam failure detection reference signal sets to be monitored is to be transmitted from the device 201 to the access node 202a. Below different examples how to indicate failure status of more than one beam failure detection reference signal set when a transmission-reception beam failure is detected by the device 201.

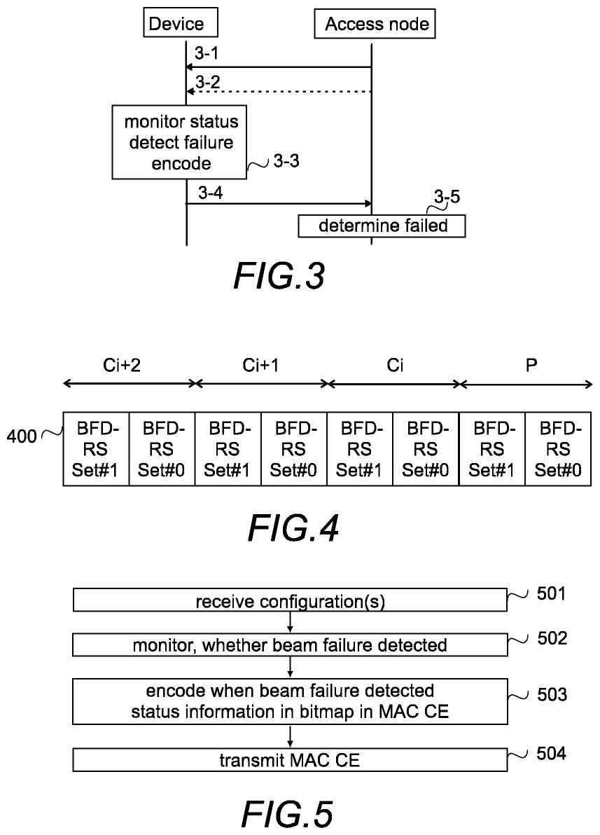

FIG. 3 illustrates a non-limiting example of information exchange for providing failure status information relating to beam failure detection. In the illustrated information exchange between a device, for example a user device, and an access node, such as a base station, representing an apparatus configured to provide wireless access and control one or more transmission-reception points, is illustrated. For example, no transmissions of beam failure detection reference signals are illustrated.

Referring to Figure, the access node configures (message 3-1) the device with beam failure recovery configuration. Message 3-1 may contain a configuration for a first beam failure detection reference signal sets (first BFD-RS sets) and for a second beam failure detection reference signal sets (second BFD-RS sets) for serving cells. Further, message 3-1, or a separate message 3-2, may contain information indicating that at least one of the serving cells is configured with a multiple beam failure detection reference signal sets (indicating a multiple transmission-reception point configuration for the corresponding serving cell). Information indicating that a serving cell is configured with the multiple beam failure detection reference signal sets for the serving cell, or for a bandwidth part of the serving cell, may refer to a configuration where control resources sets of the device, called CORESET in 5G, have been configured with a CORESET pool index value or a CORESET pool identifier value. For example, the device may be configured with at least two different pool ID values for the CORESETs, indicating an mTRP configuration, and thereby the multiple beam failure detection reference signal sets. This may imply that the device assumes a BFD-RS set per a CORESET pool identifier value. For example, if the CORESET pool identifier values are 0,1, the device may assume BFD-RS set #0 and BFD-RS set #1.

Information indicating whether there are size limitations for failure status information to be transmitted from the device may be sent, for example in message 3-1 or in a separate message 3-2. For example, the separate message 3-2 may configure resources to be used for sending the failure status information during a random access procedure. When the configured resource has a limited size, for example the failure status information is to be encoded within a MsgA or Msg3 of a random access procedure, or within any uplink grant, the failure status information may have truncated size.

Even though not illustrated in the example, the access node may configure the device with beam failure recovery configuration for the one or more serving cells.

The device, after being configured with message 3-1, or with messages 3-1 and 3-2, monitors (measures) in block 3-3 beam failure detection reference signals as configured, and when the device detects in block 3-3 a beam failure, it encodes in block 3-3 failure status information. Encoding the failure status information includes encoding into at least one bitmap in a medium access control control element, for example into a beam failure recovery medium access control control element, shortly BFR MAC CE, at least failure status information of beam failure detection of the second beam failure detection reference signal sets for at least the one of the serving cells configured with the multiple beam failure detection reference signal sets. Different ways to encode the failure status information into a BFR MAC CE are described below assuming the two sets BFD-RS set #0 and BFD-RS set #1, and use of one or two bitmaps, without limiting the number of sets and bitmaps used. In some cases, a serving cell may be configured with one BFD-RS set. For instance, zero or more serving cells may be configured with one BFD-RS set while zero or more serving cells may be configured with multiple BFD-RS sets at the same time.

In an implementation, in which two bitmaps are used, a first bitmap encoded in a BFR MAC CE indicates failure status of serving cells such that it indicates, per a serving cell, the failure status of either the serving cell or one of its BFD-RS sets. For example, failure status may be encoded in a bit position indicated for the serving cell in the bitmap, and if multiple BFD-RS sets is configured for the serving cell, the failure status is for a first BFD RS set (e.g., BFD-RS set #0) in the serving cell, otherwise the failure status is for the serving cell. For example the bit position may be as follows: a first bit is for serving cell 1, second for the serving cell 2, etc. For example, a first bit may be for a special cell, SpCell., which may be either a primary cell, PCell, or a primary secondary cell, PSCell, and other bits are for secondary cells, SCells. In the implementation, a second bitmap encoded in the BFR MAC CE indicates failure status of the second BFD-RS set (e.g., BFD-RS set #1) for serving cells for which the multiple BFD-RS sets is configured. In one example, nothing is encoded for serving cells for which multiple BFD-RS sets is not configured. In another example, the bit position indicating failure status of the second BFD-RS set for a serving cell with only one BFD-RS set configured may not be encoded at all or the bit position may be set to a specific value (e.g. bit is set to zero ‘0’ or to indicate beam failure is not detected). In an alternative example, if a serving cell is configured with only one BFD-RS set and BFR MAC CE has two bit fields for each serving cell for indicating failure statuses of BFD-RS set(s), both bits may be set to same value to indicate failure (e.g. set to 1) or the second bit may be always set to zero ‘0 or to indicate that a beam failure is not detected. In one example, the second bitmap may have a variable size, for example between 1 to 4 bytes, depending on how many of the serving cells are configured with the multiple BFD-RS sets. For example, if the size of the first bitmap is 4 bytes, it is possible to indicate failure status of 32 serving cells or their first BFD-RS set (e.g., BFD-RS set #0), and if 8 of the serving cells are configured with multiple BFD-RS sets, the second bitmap may be 1 byte enabling indicating failure status of the second BFD-RS set (e.g., BFD-RS set #1) of the 8 serving cells. The implementation takes into account serving cells that are not configured with multiple BFD-RS sets configuration and further allows to differentiate, if only one of BFD-RS sets failed, which one failed, with reasonable amount of information conveyed. In an alternative example, in any of the embodiments herein, the size of the second bitmap (e.g. that may indicate failure status of the second BFD-RS set for one or more serving cells) may be determined based on the highest serving cell index configured with multiple BFD-RS sets. The size of the bitmap may be encoded in the BFR MAC CE in full octets (or in some cases in number of bits that is used). As an example, if the highest serving cells index value with mTRP/multiple BFD-RS sets configuration (e.g. serving cell configured with more than one BFD-RS set) is 15, the second bitmap size may be set to 2 octets (e.g. having a second bit for each of the serving cells for second BFD-RS set). In another example, if the highest serving cell index with more than one BFD-RS sets (e.g. 2 sets) is 6 the second bitmap may have length of 8 bits (a full octet). In other words, the second bitmap size is based on the highest serving cell index with multiple BFD-RS sets configuration such that full octet is always used. In some examples, the extra bits left from an octet to have the full octet bitmap may be replaced with reserved bits. Serving cell indexing may start from zero ‘0’. As an example if the highest serving cell index with multiple BFD-RS sets is ‘8’ (e.g. 9 cells in total), it may mean that that 2 octets are needed. In yet another example, the first bitmap may have length (in full octets) based on the number of serving cells configured for the UE (e.g. 1 byte or up to 4 bytes). In a further example, the second bit map may have a length of the exact number of bits that need to be used (e.g. if the highest serving cell index with multiple BFD-RS sets is 5, then 5 bits are used for the second bitmap). In another example, there may be limited set of bitmap lengths for second bitmap, e.g. 1 byte and/or 4 bytes (or N bytes/M bytes). If N bytes is not enough to accommodate the information on second bitmap, M bytes (M>N) is used.

In another example, usable with any of the implementations and examples described herein, the BFD-RS set configuration (1 or multiple) may be specific for a bandwidth part of a serving cell. In one bandwidth part of a serving cell the device may be configured with one BFD-RS set and in another bandwidth part of the same serving cell the device may be configured with more than one BFD-RS sets. Thus, in some examples, the size of the bitmap may be determined based on the configuration of at least the bandwidth part with more than one BFD-RS sets for a serving cell it is counted as an mTRP cell, i.e. having multiple BFD-RS sets. For example, if at least one bandwidth part is configured with mTRP, it is considered as mTRP cell when determining the bitmap sizes based on the BFD-RS set configurations (number of BFD-RS sets) of serving cells. As an example, the failure detection itself is determined based on the BFD-RS set configuration of the current active bandwidth part (and thus the failure status indication in the BFR MAC CE). In other words, a cell is considered as a multiple BFD-RS set cell (in terms of BFR MAC CE encoding) if at least one bandwidth part of a cell is configured with multiple BFD-RS sets (this may have benefit of simplifying the MAC CE encoding and decoding). In an alternative example, the serving cell is reported in a BFR MAC CE based on the number of BFD-RS sets (one or multiple) in the current active bandwidth part.

In another implementation, the first and second bitmap encoded in the BFR MAC CE indicates failure status of the first BFD-RS set and second BFD-RS set (BFD-RS set #0 and #1) for serving cells with the multiple BFD-RS sets. The failure status information for the BFD-RS sets may be listed in an ascending order of the serving cell index for which the multiple BFD-RS sets are configured (e.g. first bitmap is provided first and second after the first bitmap). In one example, status information of SpCell (e.g. MAC CE encodes the failure status bits for both BFD-RS sets) is always included regardless whether SpCell is configured with multiple BFD-RS sets or only one BFD-RS set. As a further example, the BFR MAC CE does not include failure status information for serving cells with one BFD-RS set, i.e. nothing is encoded for serving cells for which mTRP is not configured. It is possible to use for serving cells for which one BFD-TS set is configured a legacy way (i.e. a way used in earlier generation systems to convey failure status information for serving cells configured with one BFD-RS set), or to use the BFR MAC CE for SCell.

In the implementation, the first bitmap may also have a variable size.

In an implementation, in which there is a size limitation for failure status information to be transmitted from the device, failure status information of one or more beam failure detection reference signal sets for a special cell (e.g., a primary cell or a primary secondary cell) in the second bitmap may be prioritized over failure status information of secondary cells in the first bitmap, when the failure status information is encoded. For example, a byte in the second bitmap, e.g., a first byte, which conveys failure status of the second BFD-RS set (e.g., BFD-RS set #1) of the primary cell, may be prioritized over the bytes in the first bitmap that convey information of only secondary cells. Similarly, a byte in the second bitmap, which conveys failure status of the second BFD-RS set (e.g., BFD-RS set #1) of the primary secondary cell, may be prioritized over the bytes in the first bitmap that convey information of only secondary cells. In other words, a byte with SpCell (special cell) BFD-RS set failure status information of both of the bitmaps is prioritized over other failure status information, resulting that a byte originally intended for the other failure status information is omitted. (SpCell covers herein both the primary cell and the primary secondary cell.)

In one option of the above implementation, in which there is a size limitation for failure status information to be transmitted from the device, beam failure information for the BFD-RS sets of SpCell are encoded before encoding more bytes for the bitmaps. The beam failure information may be encoded to bytes for available candidate (AC field), candidate reference signal identifiers (candidate RS ID field(s)) for beam candidates. and a reserved bit (R). The AC field indicates presence of candidate RS ID field(s). More generally, n the prioritizing is performed by encoding first the failure status information of one or more beam failure detection reference signal sets for the primary cell or the primary secondary cell to the first bitmap and to the second bitmap, then if there is free space left encoding other failure status information into the first bitmap and into the second bitmap.

When there is the size limitation for failure status information to be transmitted from the device, a first byte of failure status information may be prioritized over other failure status information if the BFD-RS failure status indicates failure for at least one of the BFD-RS sets of SpCell. A further possibility include that the candidate beam information may be prioritized over further failure status information of BFD-RS sets. As an example, if the first byte of information indicates failure of at least one BFD-RS set for SpCell, at least one candidate beam octet for at least one of the failed BFD-RS may be encoded in the BFR MAC CE. In one further variation, at least one candidate beam octet for at least one of the failed BFD-RS may be encoded in the BFR MAC CE prior to indicating further failure status of BFD-RS sets. Still a further variation includes that when failure status of a first BFD-RS set for one or more serving cells is encoded in a first octet in the BFR MAC CE, a failure of at least one BFD-RS set for SpCell may be indicated by setting a corresponding bit to indicate failure status, and then indicate in a candidate beam octet the failed BFD-RS set with candidate beam info.

In yet another example, in case both BFD-RS sets for SpCell are indicated to be in failure, the device may be configured to include during encoding in block 3-3, a candidate beam octet for one of the failed BFD-RS set(s) or the device may be configured to include the candidate beam octet for a specific BFD-RS set (BFD-RS set #0, BFD-RS set #1).

It is also possible to include to the encoded failure status information a bit indicating whether the device has completed a candidate beam search for the failed BFD-RS set. In other words, for a candidate beam octet for a failed serving cell with at least one failed BFD-RS set, that is encoded in the BFR MAC CE, a bit in the candidate beam information octet may be set to indicate whether the device has completed a candidate beam search for the failed BFD-RS set. For example, the device may indicate that no candidate (suitable) has been found and/or the device may indicate that candidate beam has not yet been completed at the encoding (building) of BFR MAC CE. However, this still allows the access node to know that failure in the given BFD-RS set has happened.

The device may be configured to encode in block 3-3 the failure status information using one bitmap instead of the above described two bitmaps, i.e. to use one bitmap to provide information on BFD-RS set failure status. The one bitmap is encoded in a BFR MAC CE, and indicates failure status of BFD-RS sets of serving cells in the order of the serving cells, for example. In other words, the device may encode, according to a predefined rule, into the one bitmap failure status information of beam failure detection of at least the first beam failure detection reference signal sets and the second beam failure detection reference signal sets for the at least the one of the serving cells configured with the multiple transmission-reception point configuration to convey the failure status information. As an example, for an octet, bit position #0 may encode the failure status information for BFD-RS set #0 of a serving cell #0 and bit position #1 may encode the failure status information for BFD-RS set #1 of the serving cell #0. In another example, the failure status information of BFD-RS sets for a serving cell may be configured to be located in adjacent bit positions in a bitmap. In a further example, an octet may encode failure status information for 4 serving cells, for each cell the BFD-RS set failure status for 2 BFD-RS sets encoded in a sequential manner. In another example, the BFD-RS sets are listed in sequential manner per each serving cell, BFD-RS sets in ascending order of the serving cell index, as illustrated with one non-limiting example in FIG. 4, in which the bitmap comprises failure status information 400 for BFD-RS set #0 and BFD-RS set #1 for 4 serving cells with serving cell indexes P,Ci,Ci+1, Ci+2, with the lowest index P for the primary cell. Still a further possibility include that two bits of each serving cell are presented as a 2 bits fields where the different indices indicate different BFD-RS set failure status. For example, index ‘00’ may indicate no failure in either BFD-RS sets; ‘01’ may indicate failure in BFD-RS set #0 but not in BFD-RS set #1; ‘10’ may indicate failure in BFD-RS set #1 but not in BFD-RS set #0; and ‘11’ may indicate failure in both BFD-RS sets. In one example, a (truncated) BFR MAC CE, when provided in a Msg3 or MsgA of the random access procedure may encode only the first byte of information that may include the failure status information for both of the BFD-RS sets for SpCell. Alternatively, the BFR MAC CE may include only one byte bitmap when the highest failed serving cell index is equal to or lower than 3. In an alternative example, the first byte of failure status information, which may include BFD-RS set failure status for SpCell, may be prioritized over a second byte of the failure status information, for example for a serving cell with index higher than 3. In another example, at least one candidate beam information/octet may be prioritized over subsequent bitmaps, which may be additional to the first bitmap with SpCell failure status information for SpCell for which the failure status information is indicated for at least one of the BFD-RS sets. In another example, the candidate beam octet may be omitted from the BFR MAC CE for SpCell, if the failure status information of both BFD-RS sets indicates a failure. In another example, when more bytes are available in the resources for the BFR MAC CE, the device encodes first the beam failure information of the BFD-RS sets of SpCell before the beam failure information of the BFD-RS sets of SCells. Furthermore, in one example, one of the BFD-RS sets of SpCell may be prioritized to be included before the other, e.g., beam failure information of the first BFD-RS set (e.g., BFD-RS set #0) is prioritized over beam failure information of the second BFD-RS set (e.g., BFD-RS set #1). In alternative example, beam failure information of the second BFD-RS set (e.g., BFD-RS set #1) is prioritized over beam failure information of the first BFD-RS set (e.g., BFD-RS set #0). In one example, if a serving cell is not configured with the multiple BFD-RS sets, the failure status information in the bitmap may occupy only 1 bit. In one alternative example, the BFR MAC CE may encode only failure status information for the serving cells configured with multiple BFD-RS sets. In one example, the length of the bitmap may be determined based on the number of configured serving cells e.g. 2 bits for each serving cell. The bitmap length may have size up to full octet. In one example, if the number of configured serving cells.

In any of the example embodiments herein, the BFR MAC CE may have multiple sizes for bitmap(s), and which one is used, may be determined based on the highest serving cell index for which the failure status information indicates a failure. In some examples, there may be a limited set of different size options (e.g N bit and M bit), and an N-bit bitmap cannot accommodate all the required information for which the M bit bitmap is used (where N<M). The bitmap may be included per a BFD-RS set (e.g. 2*N or 2*M for serving cell that are configured with one or more BFD-RS sets and N/M is the number of serving cells for which the failure status information is provided).

The size of the one bitmap may be set to be e.g. 2 or 8 bytes (2 bytes for up to 8 serving cells, 8 bytes for up to 32 serving cell), or the one bitmap may have a variable size up to a maximum limit. For example, the size may be 1, 2, 4 or 8 bytes. The size of the bitmap may be indicated by encoding corresponding information into logical channel identifying field in a medium access control sub-header. The size of the bitmap (e.g. that is used to convey the failure status information for failed serving cell/cells) may be determined based on a highest identifier or index of serving cells for which failure status information indicates failure for at least one beam failure detection reference signal set. For example, if bitmap sizes of 2 and 8 bytes are supported and if the highest (maximum) serving cell identifier of servicing cells for which at least one BFD-RS set has failed is 7, the size of the bitmap may be determined to be 2 bytes. This is because the last 6 bytes of the bitmap would only convey information of “not failed” for each serving cell/BFD-RS set, thus, this information can be implicitly encoded by providing only 2 byte bitmap.

As can be seen, also with the one bitmap it is possible to differentiate, if only one of the BFD-RS sets failed, which one failed, with reasonable amount of information conveyed.

When the failure status information is encoded (block 3-3), the failure status information is transmitted (message 3-4) in the BFR MAC CE to the access node. The access node then decodes the failure status information in block 3-5, and based on the data determines which one or ones of the BFD-RS sets has/have failed.

Further details of the beam failure recovery procedure are not disclosed herein for the clarity and concise of the description, and any known or future beam failure recovery procedure may be used.

FIGS. 5 to 8 disclose different example functionalities that the device may be configured to perform.

Referring to FIG. 5, the device receives in block 501 one or more configurations, as described above with FIG. 3. One of the configurations is configuration information configuring one or more beam failure detection reference signal sets for one or more serving cells, wherein at least one of the serving cells is configured with multiple beam failure detection reference signal sets comprising at least a first beam failure detection reference signal set and a second beam failure detection reference signal set. Another configuration that may be received is a beam failure recovery configuration.

The device then monitors in block 502, whether a beam failure is detected based on the received one or more configurations. In the illustrated example it is assumed that a beam failure is detected. When the beam failure is detected, the apparatus encodes in block 503 into at least one bitmap in a medium access control control element, MAC CE, at least failure status information of beam failure detection of the second beam failure detection reference signal set for at least the one of the serving cells configured with the multiple beam failure detection reference signals. Further examples what may be encoded in block 503 are given above with FIG. 3. Then the apparatus transmits in block 504 the medium access control element comprising the failure status information.

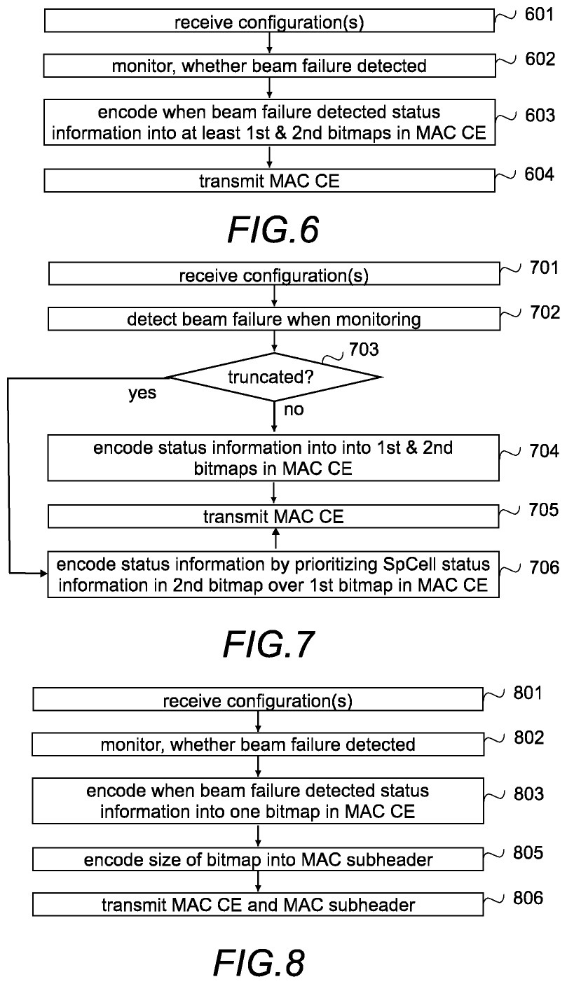

Referring to FIG. 6, the device receives in block 601 one or more configurations, as described above with FIG. 3. One of the configurations is configuration information configuring one or more beam failure detection reference signal sets for one or more serving cells, wherein at least one of the serving cells is configured with multiple beam failure detection reference signal sets comprising at least a first beam failure detection reference signal set and a second beam failure detection reference signal set. Another configuration that may be received is a beam failure recovery configuration.

The device then monitors in block 602, whether a beam failure is detected based on the received one or more configurations. In the illustrated example it is assumed that a beam failure is detected. A further assumption made is that the device is configured to use a bitmap per a beam failure detection reference signal set. When the beam failure is detected, the apparatus encodes in block 603 at least into a first bitmap in the medium access control control element MAC CE at least failure status information of the first beam failure detection reference signal set for at least the one of the serving cells configured with the multiple beam failure detection reference signal sets, and into a second bitmap in the MAC CE at least failure status information of the second beam failure detection reference signal set for at least the one of the serving cells configured with the multiple beam failure detection reference signal sets. Different examples of encoding are described above with FIG. 3.

Then the apparatus transmits in block 604 the medium access control element comprising the failure status information.

FIG. 7 illustrates another example functionality, when the device is configured to use a bitmap per a beam failure detection reference signal set.

Referring to FIG. 7, the device receives in block 701 one or more configurations, as described above with FIG. 3. One of the configurations is configuration information configuring one or more beam failure detection reference signal sets for one or more serving cells, wherein at least one of the serving cells is configured with multiple beam failure detection reference signal sets comprising at least a first beam failure detection reference signal set and a second beam failure detection reference signal set. Another configuration that may be received is a beam failure recovery configuration.

The device then monitors (not shown in FIG. 7), whether a beam failure is detected based on the received one or more configurations. In the illustrated example a beam failure is detected in block 702. The apparatus then determines in block 703, whether or not a truncated medium access control control element MAC CE is to be used. Examples when the truncated MAC CE is to be used are listed above with FIG. 3,

If the truncated MAC CE is not to be used (block 703: no), the apparatus encodes in block 704 at least into a first bitmap in the MAC CE at least failure status information of the first beam failure detection reference signal set for at least the one of the serving cells configured with the multiple beam failure detection reference signal sets, and into a second bitmap in the MAC CE at least failure status information of the second beam failure detection reference signal set for at least the one of the serving cells configured with the multiple beam failure detection reference signal sets. Different examples of encoding are described above with FIG. 3.

Then the apparatus transmits in block 705 the medium access control element comprising the failure status information.

If the truncated MAC CE is to be used (block 703: yes), the apparatus encodes in block 706 the failure status information of the beam failure detection reference signals by prioritizing SpCell failure status information, for example by prioritizing SpCell failure status information in the second bitmap over failure status information of secondary cells in the first bitmap. Different examples of how to perform the prioritizing are described above with FIG. 3.

FIG. 8 illustrates an example functionality, when the device is configured to use one bitmap for failure status information of multiple beam failure detection reference signal sets.

Referring to FIG. 8, the device receives in block 801 one or more configurations, as described above with FIG. 3. One of the configurations is configuration information configuring one or more beam failure detection reference signal sets for one or more serving cells, wherein at least one of the serving cells is configured with multiple beam failure detection reference signal sets comprising at least a first beam failure detection reference signal set and a second beam failure detection reference signal set. Another configuration that may be received is a beam failure recovery configuration.

Then the device monitors in block 802, whether a beam failure is detected based on the received one or more configurations. In the illustrated example it is assumed that a beam failure is detected. When the beam failure is detected, the apparatus encodes in block 803 into the one bitmap in a medium access control control element, MAC CE, failure status information of at least the first beam failure detection reference signal set and the second beam failure detection reference signal set. Different examples of encoding, and rules used during encoding, are described above with FIG. 3.

In the illustrated example, the device further encodes in block 805 the size of the one bitmap into a MAC subheader, for example into a logical channel identifying field. Different examples of determining the size of a bitmap and how it can be encoded are described above with FIG. 3. It should be appreciated that if the size of the bitmap is predefined/preconfigured, block 805 may be omitted.

Then the apparatus transmits in block 806 the MAC CE and the MAC subheader.

The blocks, related functions, and information exchanges described above by means of FIGS. 2 to 8 are in no absolute chronological order, and some of them may be performed simultaneously or in an order differing from the given one. Other functions can also be executed between them or within them, and other information may be transmitted. Some of the blocks or part of the blocks or one or more pieces of information can also be left out or replaced by a corresponding block or part of the block or one or more pieces of information. Further, the different implementations described for a block may be freely combined with any of different implementations of another block.

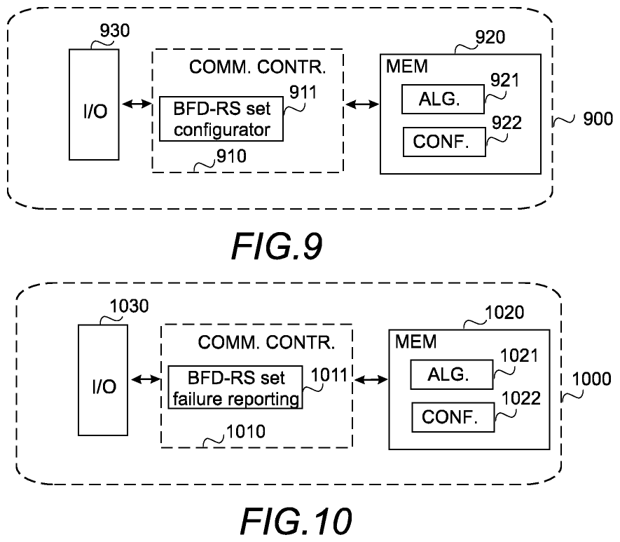

FIGS. 9 and 10 illustrate apparatuses comprising a communication controller 910, 1010 such as at least one processor or processing circuitry, and at least one memory 920, 1020 including a computer program code (software, algorithm) ALG. 921, 1021, wherein the at least one memory and the computer program code (software, algorithm) are configured, with the at least one processor, to cause the respective apparatus to carry out any one of the embodiments, examples and implementations described above. FIG. 9 illustrates an apparatus, for example a base station or an access node, configured at least to configure apparatuses (devices) to report failure status information. FIG. 10 illustrates an apparatus, for a device, such as a user equipment, or terminal device in a vehicle, or any entity served by a wireless access network, to report possible beam failures as configured by the apparatus of FIG. 9. The apparatuses of FIGS. 9 and 10 may be electronic devices, examples being listed above with FIG. 1.

Referring to FIGS. 9 and 10, the memory 920, 1020 may be implemented using any suitable data storage technology, such as semiconductor based memory devices, flash memory, magnetic memory devices and systems, optical memory devices and systems, fixed memory and removable memory. The memory may comprise a configuration storage CONF. 921, 1021, such as a configuration database, for example for configurations on beam failure detection reference signal sets for serving cells. The memory 920, 1020 may further store other data.

Referring to FIG. 9, the apparatus comprises a communication interface 930 comprising hardware and/or software for realizing communication connectivity according to one or more wireless and/or wired communication protocols. The communication interface 930 may provide the apparatus with radio communication capabilities with different apparatuses, for example with the apparatus of FIG. 10 and towards transmission-reception points, as well as communication capabilities towards the core network.

Digital signal processing regarding transmission and reception of signals may be performed in a communication controller 910. The communication interface may comprise standard well-known components such as an amplifier, filter, frequency-converter, (de) modulator, and encoder/decoder circuitries and one or more antennas.

The communication controller 910 comprises a beam failure detection reference signal set configuring circuitry 911 (BFD-RS set configurator) configured to configure devices to report failure status information according to any one of the embodiments/examples/implementations described above. The beam failure detection reference signal set configuring circuitry 911 may further be configured to configure beam recovery procedures. The communication controller 910 may control the beam failure detection reference signal set configuring circuitry 911.

In an embodiment, at least some of the functionalities of the apparatus of FIG. 9 may be shared between two physically separate apparatuses, forming one operational entity. Therefore, the apparatus may be seen to depict the operational entity comprising one or more physically separate apparatuses for executing at least some of the processes described with an access node.

Referring to FIG. 10, the apparatus 1000 may further comprise a communication interface 1030 comprising hardware and/or software for realizing communication connectivity according to one or more wireless communication protocols. The communication interface 1030 may provide the apparatus 1000 with communication capabilities with the apparatus of FIG. 9 and with transmission-reception points, for example. The communication interface may comprise standard well-known analog components such as an amplifier, filter, frequency-converter and circuitries, conversion circuitries transforming signals between analog and digital domains, and one or more antennas. Digital signal processing regarding transmission and reception of signals may be performed in a communication controller 1010.

The communication controller 1010 comprises a beam failure detection reference signal set reporting circuitry 1011 (BFD-RS set failure reporting) configured to report, when a beam failure is detected, failure status information according to any one of the embodiments/examples/implementations described above. The communication controller 1010 may control the beam failure detection reference signal set reporting circuitry 1011.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described in connection with FIGS. 2 to 8 may be carried out by an apparatus comprising corresponding means for carrying out at least some of the described processes. The apparatus may comprise separate means for separate phases of a process, or means may perform several phases or the whole process. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments/examples/implementations described herein.

According to yet another embodiment, the apparatus carrying out the embodiments/examples comprises a circuitry including at least one processor and at least one memory including computer program code. When activated, the circuitry causes the apparatus to perform at least some of the functionalities according to any one of the embodiments/examples/implementations of FIGS. 2 to 8, or operations thereof.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g, procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the apparatuses described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments/examples/implementations as described may also be carried out in the form of a computer process defined by a computer program or portions thereof. Embodiments of the methods described in connection with FIGS. 2 to 8 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium, for example. Coding of software for carrying out the embodiments as shown and described is well within the scope of a person of ordinary skill in the art. In an embodiment, a computer-readable medium comprises said computer program.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1.-16. (canceled)

17. An apparatus comprising
at least one processor; and
at least one memory including instructions, the at least one memory and instructions being configured to, with the at least one processor, cause the apparatus at least to:
receive, from a base station, configuration information configuring two or more beam failure detection reference signal sets for one or more serving cells, the two or more beam failure detection reference signal sets comprising at least a first beam failure detection reference signal set and a second beam failure detection reference signal set;
monitor, whether beam failure is detected based on the configuration information;
encode, when the beam failure is detected for the first beam failure detection reference signal set and the second beam failure detection reference signal set, into at least two bitmaps in a medium access control control element failure status information of the first beam failure detection reference signal set and failure status information of the second beam failure detection reference signal set; and
transmit the medium access control control element comprising the failure status information of the first beam failure detection reference signal set and the failure status information of the second beam failure detection reference signal set.

18. The apparatus of claim 17, wherein the at least one memory and instructions are configured to, with the at least one processor, cause the apparatus further at least to:
encode into a first bitmap in the medium access control control element at least the failure status information of the first beam failure detection reference signal set; and
encode into a second bitmap in the medium access control control element at least the failure status information of the second beam failure detection reference signal set.

19. The apparatus of claim 18, wherein the at least one memory and instructions are configured to, with the at least one processor, cause the apparatus further at least to:
encode, if a serving cell is not configured with multiple beam failure detection reference signal sets, into the first bitmap failure status information of the serving cell.

20. The apparatus of claim 17, wherein the at least one memory and instructions are configured to, with the at least one processor, cause the apparatus further at least to:
perform the prioritizing by encoding first the failure status information of one or more beam failure detection reference signal sets for the primary cell or the primary secondary cell to the first bitmap and to the second bitmap, then if there is free space left encoding other failure status information into the first bitmap and into the second bitmap.

21. The apparatus of claim 17, wherein the at least one memory and instructions are configured to, with the at least one processor, cause the apparatus further at least to:
perform the prioritizing by prioritizing a first byte of the failure status information indicating failure for at least one of the beam failure detection reference signal sets for the primary cell or the primary secondary cell over other failure status information.

22. The apparatus of claim 17, wherein the at least one memory and instructions are configured to, with the at least one processor, cause the apparatus further at least to:
encode, according to a predefined rule, into a second bitmap of the at least two bitmaps the failure status information related to at least the first beam failure detection reference signal set and the second beam failure detection reference signal set for at least one of the one or more serving cells configured with the two or more beam failure detection reference signal sets.

23. The apparatus of claim 22, wherein the at least one memory and instructions are configured to, with the at least one processor, cause the apparatus further at least to:
determine size of at least one bitmap of the at least two bitmaps based on highest index of serving cells for which failure status information indicates failure for at least one beam failure detection reference signal set.

24. A method comprising:
receiving, from a base station, configuration information configuring two or more beam failure detection reference signal sets for one or more serving cells, the two or more beam failure detection reference signal sets comprising at least a first beam failure detection reference signal set and a second beam failure detection reference signal;
monitoring, whether beam failure is detected based on the configuration information;
encoding, when the beam failure is detected for the first beam failure detection reference signal set and the second beam failure detection reference signal set, into at least two bitmaps in a medium access control control failure status information of the first beam failure detection reference signal set and failure status information of beam failure detection of the second beam failure detection reference signal set; and
transmitting the medium access control element comprising the failure status information of the first beam failure detection reference signal set and failure status information of the second beam failure detection reference signal set.

25. The method of claim 24, comprising:
encoding into a first bitmap in the medium access control control element at least the failure status information of the first beam failure detection reference signal set; and
encoding into a second bitmap in the medium access control control element at least the failure status information of the second beam failure detection reference signal set.

26. The method of claim 25, comprising:
encoding, if a serving cell is not configured with multiple beam failure detection reference signal sets, into the first bitmap failure status information of the serving cell.

27. The method of claim 24, comprising:
performing prioritizing by encoding first failure status information of one or more beam failure detection reference signal sets for the primary cell or the primary secondary cell to the first bitmap and to the second bitmap, then if there is free space left encoding other failure status information into the first bitmap and into the second bitmap.

28. The method of claim 24, comprising:
performing the prioritizing by prioritizing a first byte of the failure status information indicating failure for at least one of the beam failure detection reference signal sets for the primary cell or the primary secondary cell over other failure status information.

29. The method of claim 24, comprising:
encoding, according to a predefined rule, into a second bitmap of the at least two bitmaps the failure status information related to at least the first beam failure detection reference signal set and the second beam failure detection reference signal set for at least one of the serving cells configured with the two or more beam failure detection reference signal sets.

30. The apparatus of claim 29, comprising:
determining size of at least one bitmap of the at least two bitmaps based on highest index of serving cells for which failure status information indicates failure for at least one beam failure detection reference signal set.

31. A non-transitory computer readable medium comprising instructions which, when executed by an apparatus, cause the apparatus to carry out:
receiving, from a base station, configuration information configuring two or more beam failure detection reference signal sets for one or more serving cells, the two or more beam failure detection reference signal sets comprising at least a first beam failure detection reference signal set and a second beam failure detection reference signal;
monitoring, whether beam failure is detected based on the configuration information;
encoding, when the beam failure is detected for the first beam failure detection reference signal set and the second beam failure detection reference signal set, into at least two bitmaps in a medium access control control element failure status information of the first beam failure detection reference signal set and failure status information of the second beam failure detection reference signal set; and
transmitting the medium access control element comprising the failure status information of the first beam failure detection reference signal set and failure status information of the second beam failure detection reference signal set.

32. The non-transitory computer readable medium of claim 31, comprising:
encoding into a first bitmap in the medium access control control element at least the failure status information of the first beam failure detection reference signal set; and
encoding into a second bitmap in the medium access control control element at least the failure status information of the second beam failure detection reference signal set.

33. The non-transitory computer readable medium of claim 32, comprising:
encoding, if a serving cell is not configured with multiple beam failure detection reference signal sets, into the first bitmap failure status information of the serving cell.

34. The non-transitory computer readable medium of claim 31, comprising:
performing prioritizing by encoding first failure status information of one or more beam failure detection reference signal sets for the primary cell or the primary secondary cell to the first bitmap and to the second bitmap, then if there is free space left encoding other failure status information into the first bitmap and into the second bitmap.

35. The non-transitory computer readable medium of claim 31, comprising:
encoding, according to a predefined rule, into a second bitmap of the at least two bitmaps the failure status information related to at least the first beam failure detection reference signal set and the second beam failure detection reference signal set for at least one of the serving cells configured with the two or more beam failure detection reference signal sets.

36. The non-transitory computer readable medium of claim 35, comprising:
determining size of at least one bitmap of the at least two bitmaps based on highest index of serving cells for which failure status information indicates failure for at least one beam failure detection reference signal set.
